(19) United States
(12) Patent Application Publication
(10) Pub. No.: US 2005/0015592 A1
(43) Pub. Date: Jan. 20, 2005

(54) System and method for application and user-based class of security

(76) Inventor: Jeou-Kai Lin, Campbell, CA (US)

Correspondence Address: FORTUNE LAW GROUP, 100 Century Center Ct., San Jose, CA, 95112, US

(21) Appl. No.: 10/891,164

(22) Filed: Jul. 14, 2004

Related U.S. Application Data
(60) Provisional application No. 60/487,466, filed on Jul. 15, 2003.

(51) Int. Cl. H04L 9/00

(52) U.S. Cl. 713/166

(57) ABSTRACT

A method for automatically adjusting the security level for a given application and specific user includes the steps of determining a security level assigned to the application, determining whether the security level is dependent upon a type of specific user, executing the application without security if no security level is assigned to the application and if the security level is not dependent upon the type of specific user, executing the application with security if the application has an assigned security level and if the security level is not dependent upon the type of specific user, assigning the security level if the security is dependent upon the type of specific user, and executing the application with the assigned security level dependent upon the type of specific user.

### CROSS REFERENCE TO RELATED APPLICATIONS

The present application claims priority under 35 U.S.C. 119(e) from provisional patent application Ser. No. 60/487,466, entitled “System and Method for Application and User-Based Class of Security”, filed on Jul. 15, 2003, the disclosure of which is herein incorporated by reference in its entirety.

### BACKGROUND OF THE INVENTION

The present invention generally relates to network security and more particularly to a system and method for application and user-based class of security.

While security is of great concern to network users, it is not practical to have the same level of security for every user in every situation at all times. Higher level security usually means slower transmission rates and higher bandwidth usage. In addition, the power consumption also increases whenever a higher security is required. These concerns are of increased importance in mobile networked devices. For instance, an Internet gaming application or a multimedia discussion board application may not require much security but may require faster transmission and real time response. Further, a human resource manager or an accountant may require higher security than a factory worker. Thus the security needs of different applications and users are very different.

No prior art system and method is operable to automatically adjust the security level given an application and/or a specific user. As such there is a need for a system and method that automatically adjusts the security level given an application and/or a specific user. Different security levels may have associated therewith different security schemes.

### SUMMARY OF THE INVENTION

In accordance with one aspect of the invention, a method for automatically adjusting the security level for a given application and specific user includes the steps of determining a security level assigned to the application, determining whether the security level is dependent upon a type of specific user, executing the application without security if no security level is assigned to the application and if the security level is not dependent upon the type of specific user, executing the application with security if the application has an assigned security level and if the security level is not dependent upon the type of specific user, assigning the security level if the security is dependent upon the type of specific user, and executing the application with the assigned security level dependent upon the type of specific user.

In accordance with another aspect of the invention, a system for automatically adjusting the security level for a given application and specific user includes a memory comprising program instructions, and a processor coupled to the memory, the processor operable to execute the program instructions to perform the operations of determining a security level assigned to the application, determining whether the security level is dependent upon a type of specific user, executing the application without security if no security level is assigned to the application and if the security level is not dependent upon the type of specific user, executing the application with security if the application has an assigned security level and if the security level is not dependent upon the type of specific user, assigning the security level if the security is dependent upon the type of specific user, and executing the application with the assigned security level dependent upon the type of specific user.

In accordance with yet another aspect of the invention, a computer-readable medium containing one or more instructions for automatically adjusting the security level for a given application and specific user includes a code segment for determining a security level assigned to the application, a code segment for determining whether the security level is dependent upon a type of specific user, a code segment for executing the application without security if no security level is assigned to the application and if the security level is not dependent upon the type of specific user, a code segment for executing the application with security if the application has an assigned security level and if the security level is not dependent upon the type of specific user, a code segment for assigning the security level if the security is dependent upon the type of specific user, and a code segment for executing the application with the assigned security level dependent upon the type of specific user.

These and other features, aspects and advantages of the present invention will become better understood with reference to the following drawings, description and claims.

### BRIEF DESCRIPTION OF THE DRAWINGS

FIG. 1 is a flow diagram of a method in accordance with the present invention; and

FIG. 2 is a schematic representation of a system in accordance with the present invention.

### DETAILED DESCRIPTION OF THE INVENTION

The following detailed description is of the best mode of carrying out the invention. The description is not to be taken in a limiting sense, but is made merely for the purpose of illustrating the general principles of the invention, since the scope of the invention is best defined by the appended claims.

The present invention generally provides a method operable to automatically adjust the security level given an application and/or a specific user.

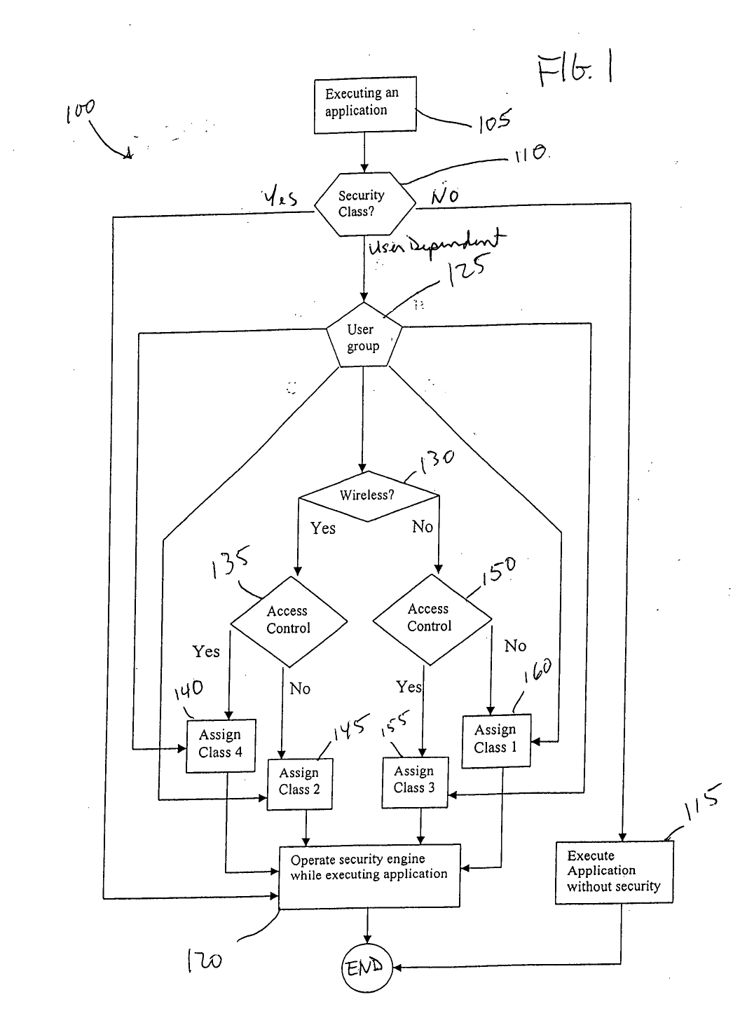

With reference to FIG. 1, a method for automatically adjusting the security level given an application and/or a specific user is shown generally designated 100. In a step 105 execution of an application is initiated and in a step 110a security level assigned to the application is checked as well as whether the security level is dependent upon the type of specific user. If no security level is assigned to the application and the security level is not dependent upon the type of specific user, then in a step 115 the application is executed without security. If the security level is determined to be either authentication (class 1), authentication plus encryption (class 2), authentication plus access control (class 3), or authentication plus encryption plus access control (class 4), and the security level is not dependent upon the type of specific user, then in a step 120 a security engine is operated while executing the application in accordance with the class assigned to the application.

If the security level is dependent upon the type of specific user, then a specific user group is determined in a step 125. For purposes of illustration, a user may be classified as being in Group A assigned class 4 security, Group B assigned class 3 security, Group C assigned class 2 security, or Group D assigned class 1 security. If the status of the user cannot be determined (Group Z), a step 130 determines if the user is using a wireless device. If the user is using a wireless device then in a step 135 it is determined if access control is required. If access control is required then class 4 security is assigned in a step 140, otherwise class 2 security is assigned in a step 145. If the user is not using a wireless device then in a step 150 it is determined if access control is required. If access control is required then class 3 security is assigned in a step 155, otherwise class 1 security is assigned in a step 160. After the assignment of a security class in steps 140, 145, 155, and 160, the security engine is operated while executing the application in step 120.

The method 100 of the invention enables those in charge of security to make advance determinations regarding security levels of both applications and users. For example, a corporation may assign security level class 2 to an email application for its employees who use the application. When a user opens the application, step 120 of method 100 is automatically performed. On the other hand a corporation employing mobile employees using mobile devices may make the email application user dependent, assign its employees to Group Z and further require access control. The method 100 of the invention automatically assigns security class 4 to the email application being accessed by the mobile users.

Advantageously the method of the present invention automatically adjusts the security level with higher throughput and lower power consumption. The method further automates the process of power saving and bandwidth usage once initialized. Finally, the method requires no management after initialization and configuration.

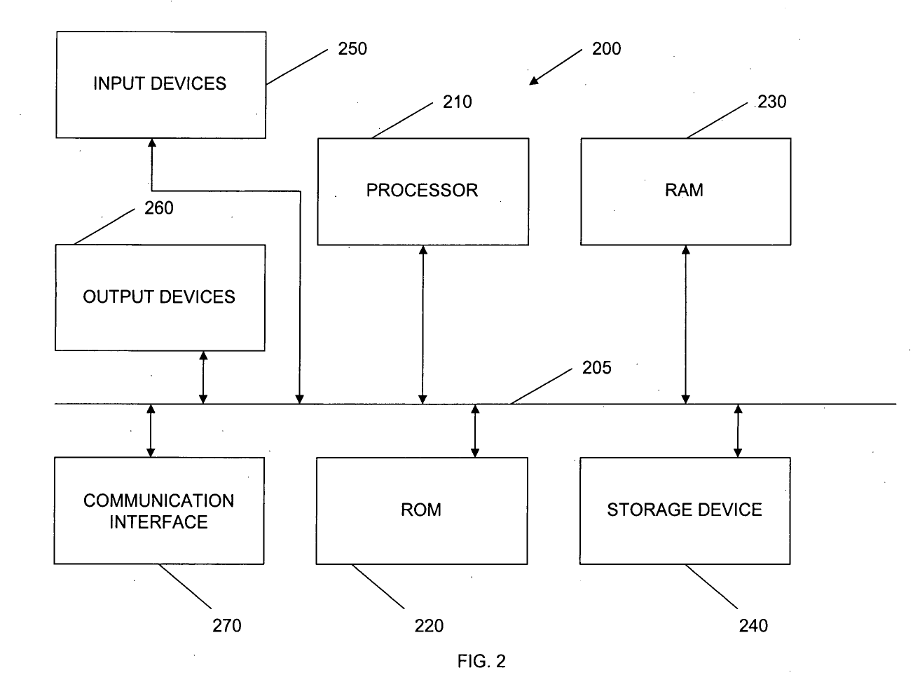

A system generally designated 200 shown in FIG. 2 may be operable to implement the method 100. System 200 may include a processor 210 coupled to a bus 205. Processor 210 may be operable to execute instructions stored in a read only memory device 220 and a random access memory device 230 which may be coupled to bus 205. Instructions stored in read only memory device 220 and random access memory device 230 may be operable to implement the method 100. System 200 may further include a storage device 240, input devices 150, output devices 260, and communication interface 270 coupled to bus 205.

In another aspect of the invention, a computer readable medium may be operable to store computer readable code operable to implement the method 100. Code segments stored in computer readable medium may be operable to instruct processor 210 to implement the method 100.

It should be understood, of course, that the foregoing relates to preferred embodiments of the invention and that modifications may be made without departing from the spirit and scope of the invention.

1. A method for automatically adjusting the security level for a given application and specific user comprising the steps of:
determining a security level assigned to the application;
determining whether the security level is dependent upon a type of specific user;
executing the application without security if no security level is assigned to the application and if the security level is not dependent upon the type of specific user;
executing the application with security if the application has an assigned security level and if the security level is not dependent upon the type of specific user;
assigning the security level if the security is dependent upon the type of specific user; and
executing the application with the assigned security level dependent upon the type of specific user.

2. The method as claimed in claim 1, wherein the security levels comprise authentication, authentication plus encryption, authentication plus access control, and authentication plus encryption plus access control.

3. The method as claimed in claim 2, wherein assigning the security level if the security is dependent upon the type of specific user further comprises determining if the specific user is using a wireless device in a case were the type of the specific user cannot be determined, determining if access control is required, assigning authentication plus encryption plus access control if the specific user is using the wireless device and access control is required, assigning authentication plus encryption if the specific user is using the wireless device and access control is not required, assigning authentication plus access control if the specific user is not using the wireless device and access control is required, and assigning authentication if the specific user is not using the wireless device and access control is not required.

4. A system for automatically adjusting the security level for a given application and specific user comprising:
a memory comprising program instructions; and
a processor coupled to the memory, the processor operable to execute the program instructions to perform the operations of determining a security level assigned to the application, determining whether the security level is dependent upon a type of specific user, executing the application without security if no security level is assigned to the application and if the security level is not dependent upon the type of specific user, executing the application with security if the application has an assigned security level and if the security level is not dependent upon the type of specific user, assigning the security level if the security is dependent upon the type of specific user, and executing the application with the assigned security level dependent upon the type of specific user.

5. The system as claimed in claim 4, wherein the security levels comprise authentication, authentication plus encryption, authentication plus access control, and authentication plus encryption plus access control.

6. The system as claimed in claim 5, wherein assigning the security level if the security is dependent upon the type of specific user further comprises determining if the specific user is using a wireless device in a case were the type of the specific user cannot be determined, determining if access control is required, assigning authentication plus encryption plus access control if the specific user is using the wireless device and access control is required, assigning authentication plus encryption if the specific user is using the wireless device and access control is not required, assigning authentication plus access control if the specific user is not using the wireless device and access control is required, and assigning authentication if the specific user is not using the wireless device and access control is not required.

7. A computer-readable medium containing one or more instructions for automatically adjusting the security level for a given application and specific user comprising:
a code segment for determining a security level assigned to the application;
a code segment for determining whether the security level is dependent upon a type of specific user;
a code segment for executing the application without security if no security level is assigned to the application and if the security level is not dependent upon the type of specific user;
a code segment for executing the application with security if the application has an assigned security level and if the security level is not dependent upon the type of specific user;
a code segment for assigning the security level if the security is dependent upon the type of specific user; and
a code segment for executing the application with the assigned security level dependent upon the type of specific user.

8. The computer-readable medium as claimed in claim 7, wherein the security levels comprise authentication, authentication plus encryption, authentication plus access control, and authentication plus encryption plus access control.

9. The computer-readable medium as claimed in claim 8, wherein assigning the security level if the security is dependent upon the type of specific user further comprises determining if the specific user is using a wireless device in a case were the type of the specific user cannot be determined, determining if access control is required, assigning authentication plus encryption plus access control if the specific user is using the wireless device and access control is required, assigning authentication plus encryption if the specific user is using the wireless device and access control is not required, assigning authentication plus access control if the specific user is not using the wireless device and access control is required, and assigning authentication if the specific user is not using the wireless device and access control is not required.
